(19) United States
(12) Patent Application Publication
(10) Pub. No.: US 2019/0075278 A1
(43) Pub. Date: Mar. 7, 2019

(54) VIDEO ENCODING CIRCUIT, VIDEO OUTPUT SYSTEM, AND CORRESPONDING VIDEO SIGNAL ENCODING METHOD

(71) Applicant: ALi Corporation, Hsinchu City (TW)

(72) Inventor: Jian-Shiang Fang, Taipei City (TW)

(21) Appl. No.: 15/811,843

(22) Filed: Nov. 14, 2017

(30) Foreign Application Priority Data
Sep. 4, 2017 (CN) 201710786874.8

(51) Int. Cl. H04N 9/78; H04N 19/186; H04N 5/04; H04N 19/42

(52) U.S. Cl. CPC H04N 9/78; H04N 19/42; H04N 5/04; H04N 19/186

(57) ABSTRACT

A video encoding circuit electrically connected to a digital to analog converter (DAC) for encoding a first digital image signal to a second digital image signal is provided. The first digital image signal includes a luminance signal, a color signal and a decoding synchronization signal. The video encoding circuit includes a compensation circuit, a color generation circuit and a video composite circuit. The compensation circuit determines a selected level corresponding to the luminance signal. The color generation circuit electrically connected to the compensation circuit generates a color carrier signal according to the selected level and the color signal. The video composite circuit is connected to the color generation circuit, the compensation circuit, and the DAC. The video composite circuit generates the second digital image signal according to the luminance signal, the decoding synchronization signal, and the color carrier signal, and outputs the second digital image signal to the DAC.

This application claims the benefit of People's Republic of China application Serial No. 201710786874.8, filed Sep. 4, 2017, the subject matter of which is incorporated herein by reference.

### BACKGROUND OF THE INVENTION

### Field of the Invention

The invention relates in general to a video encoding circuit, a video output system and a corresponding video signal encoding method, and more particularly to a video encoding circuit, a video output system and a corresponding video signal encoding method used in a composite video baseband signal (CVBS).

### Description of the Related Art

Generally speaking, the signals in the video output system (such as a set-top box) are normally processed in the form of digital signals. Since the TV plays programs and displays images by using analog signals, the video signals in the video output system must be processed by digital to analog conversion, so that the outputted video signal can be played on the TV.

Since the digital to analog conversion curve of the digital to analog converter (DAC) of the video output system for performing digital to analog conversion may often be non-linear, the performance of the digital to analog conversion of the video signal may not be acceptable. Therefore, how to resolve the problem which occurs due to the non-linear characteristics of the DAC so as to improve the quality of the video signal has become a prominent task for the industries.

### SUMMARY OF THE INVENTION

The disclosure is directed to a video encoding circuit, a video output system and a corresponding video signal encoding method of. Through the use of a look-up table, the present disclosure can effectively compensate the problem, which occurs due to the non-linearity of the DAC, at a low cost.

According to one embodiment of the disclosure, a video encoding circuit electrically connected to a DAC for encoding a first digital image signal to a second digital image signal is provided. The first digital image signal includes a luminance signal, a color signal and a decoding synchronization signal. The video encoding circuit includes a compensation circuit, a color generation circuit and a video composite circuit. The compensation circuit determines a selected level corresponding to the luminance signal. The color generation circuit is electrically connected to the compensation circuit for generating a color carrier signal according to the selected level and the color signal. The video composite circuit is electrically connected to the color generation circuit, the compensation circuit, and the DAC. The video composite circuit generates the second digital image signal according to the luminance signal, the decoding synchronization signal, and the color carrier signal, and outputs the second digital image signal to the DAC.

According to another embodiment of the disclosure, a video output system electrically connected to a TV is provided. The output system includes a video encoding circuit and a digital to analog converter (DAC). The video encoding circuit encodes a first digital image signal to a second digital image signal. The first digital image signal includes a luminance signal, a color signal and a decoding synchronization signal. The video encoding circuit includes a compensation circuit, a color generation circuit and a video composite circuit. The compensation circuit determines a selected level corresponding to the luminance signal. The color generation circuit is electrically connected to the compensation circuit for generating a color carrier signal according to the selected level and the color signal. The video composite circuit is electrically connected to the color generation circuit and the compensation circuit. The video composite circuit generates the second digital image signal according to the luminance signal, the decoding synchronization signal and the color carrier signal. The DAC is electrically connected to the video encoding circuit for encoding the second digital image signal to an analog composite video baseband signal and then outputting the analog composite video baseband signal to TV.

According to an alternate embodiment of the disclosure, a video signal encoding method used in a video encoding circuit for encoding a first digital image signal to a second digital image signal is provided. The digital image signal includes a luminance signal, a color signal, and a decoding synchronization signal. The encoding method includes: determining a selected level corresponding to the luminance signal; generating a color carrier signal according to the selected level and the color signal; generating the second digital image signal according to the luminance signal, the decoding synchronization signal, and the color carrier signal; and outputting the second digital image signal to a DAC.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 shows an ideal conversion curve and non-ideal conversion curve of a DAC.

FIG. 2 shows a schematic diagram showing the phase of an output signal of a DAC being affected by the non-linearity of the conversion curve.

FIG. 3 shows a block diagram of a video output system according to an exemplary embodiment of the disclosure.

FIG. 4 shows a schematic diagram of an example of partial waveform of a TV frame transmitted according to the standard of the composite video baseband signal.

FIG. 5 is an example of a waveform diagram of a composite luminance signal Y′ corresponding to the image of a particular line of a field.

FIG. 6 shows an example of an analog composite video baseband signal CVBS1.

FIG. 7 is a schematic diagram of outputted differential phase of a DAC obtained from the same color information under different luminance levels.

FIG. 8 is a schematic diagram of outputted differential phase of a DAC obtained from the same color information under different luminance levels using the video encoding circuit according to an embodiment of the present disclosure.

### DETAILED DESCRIPTION OF THE INVENTION

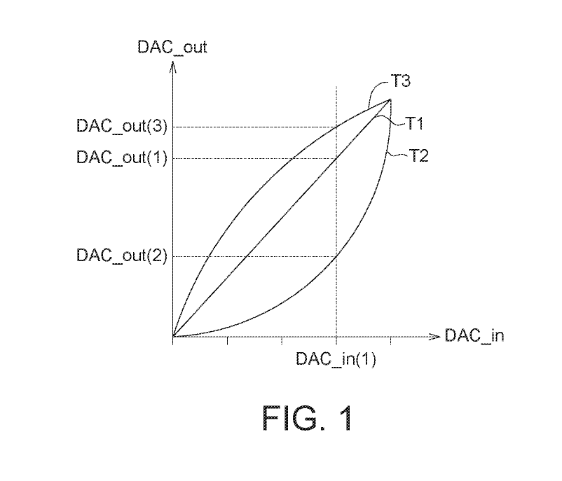

Referring to FIG. 1, an ideal conversion curve and non-ideal conversion curve of a DAC is shown. The vertical axis represents the analog output voltage DAC_out of the digital to analog converter (DAC), and the horizontal axis represents the input digital value DAC_in of the DAC. The conversion curve T1 represents an ideal linear conversion function of the DAC. That is, for the DAC, the ideal conversion curve is obtained when the relationship of the input digital value DAC_in and the analog output voltage DAC_out is linear.

It is possible that the conversion curve of the DAC may be non-linear. For example, the non-linearity may be caused by process deviation. The two conversion curves T2 and T3 are two examples of non-ideal conversion curves of the DAC. Given the same input digital value DAC_in(1), the analog output voltage DAC_out(2) obtained from the conversion curve T2 is smaller than the analog output voltage DAC_out(1) obtained from the conversion curve T1. The analog output voltage DAC_out(3) obtained from the conversion curve T3 is larger than the analog output voltage DAC_out(1) obtained from the conversion curve T1. The phase of the carrier signal carrying color information in the composite video baseband signal (CVBS) of the video output system may be leading or lagging due to the non-ideal conversion curves T2 and T3 of the DAC.

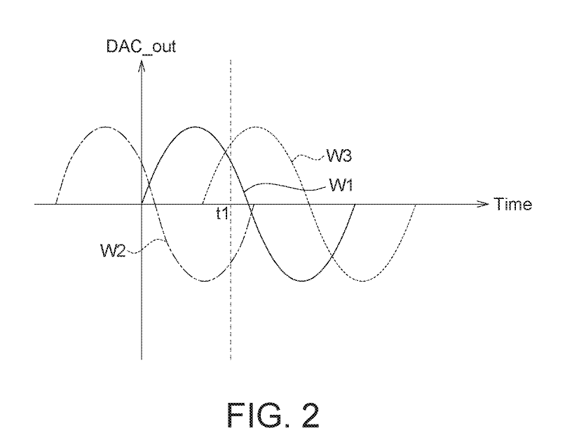

Referring to FIG. 2, a schematic diagram showing the phase of an output signal of a DAC being affected by the non-linearity of the conversion curve is shown. The vertical axis represents the analog output voltage DAC_out, and the horizontal axis represents time. In FIG. 2, the waveforms W1, W2, and W3 are sine wave signals obtained based on the corresponding conversion curves T1, T2, and T3 respectively. As indicated in FIG. 2, due to the non-linearity of the conversion curve T3, the phase of the waveform W3 leads the phase of the waveform W1. Similarly, the phase of the waveform W2 lags the phase of the waveform W1. Due to phase difference, both the voltage of the waveform W3 and the voltage of the waveform W2 are different from the voltage of the waveform W1 at time point t1, thereby causing the problem of signal distortion.

The color information of the composite video baseband signal is modulated by adjusting the phase of the carrier signal. If the phase of the carrier signal is leading or lagging, the to-be-transmitted color information will be distorted. To resolve the above problem of color distortion, which occurs when the phase of the carrier signal carrying color information in the composite video baseband signal outputted from the DAC is affected by the non-linearity of the conversion curve, a number of embodiments are provided below.

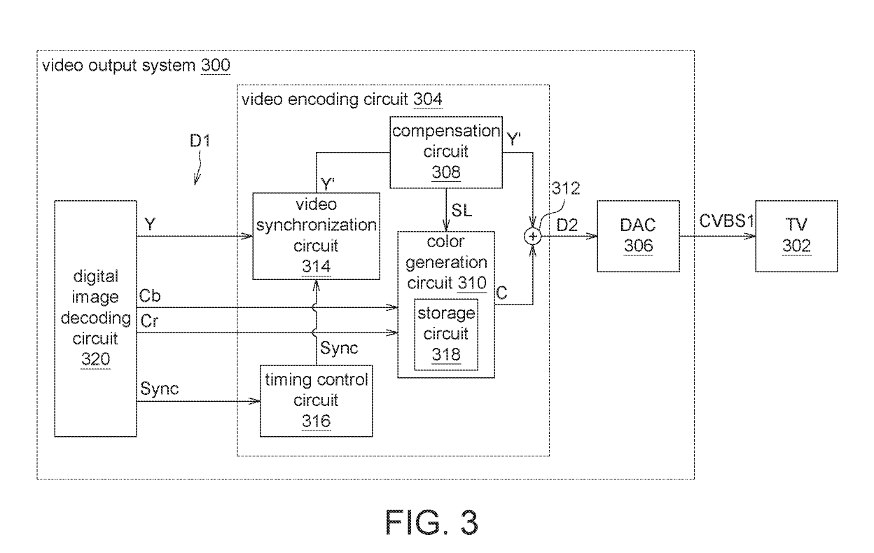

Referring to FIG. 3, a block diagram of a video output system according to an exemplary embodiment of the disclosure is shown. The video output system 300 is electrically connected to a TV 302. The video output system 300 includes a video encoding circuit 304 and a DAC 306. The video encoding circuit 304 encodes a first digital image signal D1 to a second digital image signal D2. The first digital image signal D1 includes a luminance signal Y, a color signal, and a decoding synchronization signal Sync. The color signal includes a blue color signal Cb and a red color signal Cr, which are represented by color signals Cb and Cr hereinafter. The decoding synchronization signal Sync includes a horizontal synchronization signal Hsync and a vertical synchronization signal Vsync.

The video encoding circuit 304 includes a compensation circuit 308, a color generation circuit 310, and a video composite circuit 312. The compensation circuit 308 determines a selected level SL corresponding to the luminance signal Y. The color generation circuit 310 is electrically connected to the compensation circuit 308 for generating the color carrier signal C according to the selected level SL and the color signals Cb and Cr. The video composite circuit 312 is electrically connected to the color generation circuit 310 and the compensation circuit 308. The video composite circuit 312 generates the second digital image signal D2 according to the luminance signal Y, the decoding synchronization signal Sync, and the color carrier signal C.

The DAC 306 is electrically connected to the video encoding circuit 304 for converting the second digital image signal D2 to an analog composite video baseband signal CVBS1, and then outputting the analog composite video baseband signal CVBS1 to the TV 302 for the TV 302 to play a color video frame.

The video output system 300 further includes a digital image decoding circuit 320 used for outputting the first digital image signal D1 including a luminance signal Y, color signals Cb and Cr, and the decoding synchronization signal Sync. The digital image decoding circuit 320 can be realized by an MPEG decoder or an H.264 decoder capable of decoding a three primary colors (RGB) signal to the luminance signal Y and the color signals Cb and Cr in the embodiment.

The color generation circuit 310 converts the color signals Cb and Cr to a chrominance signal U and a chroma signal V according to the standard of the composite video baseband signal. Then, the color generation circuit 310 adjusts the phase of the chrominance signal U and the phase of the chroma signal V according to the selected level SL provided by the compensation circuit 308 and then the color generation circuit 310 generates the color carrier signal C according to the phase-adjusted chrominance signal U and the phase-adjusted chroma signal V.

Additionally, the video encoding circuit 304 further includes a video synchronization circuit 314 and a timing control circuit 316. The timing control circuit 316 receives the decoding synchronization signal Sync and then transmits the decoding synchronization signal Sync to the video synchronization circuit 314. The video synchronization circuit 314 combines the luminance signal Y with the decoding synchronization signal Sync to obtain a composite luminance signal Y′. It can be regarded that the composite luminance signal Y′ includes both the luminance signal Y and the decoding synchronization signal Sync.

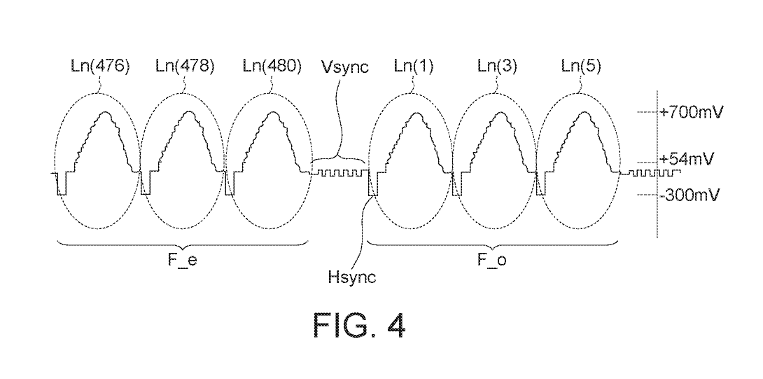

Referring to FIG. 4, a schematic diagram of an example of partial waveform of a TV frame transmitted according to the standard of the composite video baseband signal is shown. The left-hand side of FIG. 4 corresponds to an even field F_e of a frame and the right-hand side of FIG. 4 corresponds to an odd field F_o of the next frame. In order to distinguish the even field F_e and the odd field F_o, the composite video baseband signal additionally includes a vertical synchronization signal Vsync used as the synchronization signal of the field.

Each field has a number of lines. For example, the even field F_e includes a waveform corresponding to the 476^{th} line Ln(476), the 478^{th} line Ln(478), and the 480^{th} line Ln(480); the odd field F_o includes a waveform corresponding to the 1^{st} line Ln(1), the 3^{rd} line Ln(3), and the 5^{th} line Ln(5).

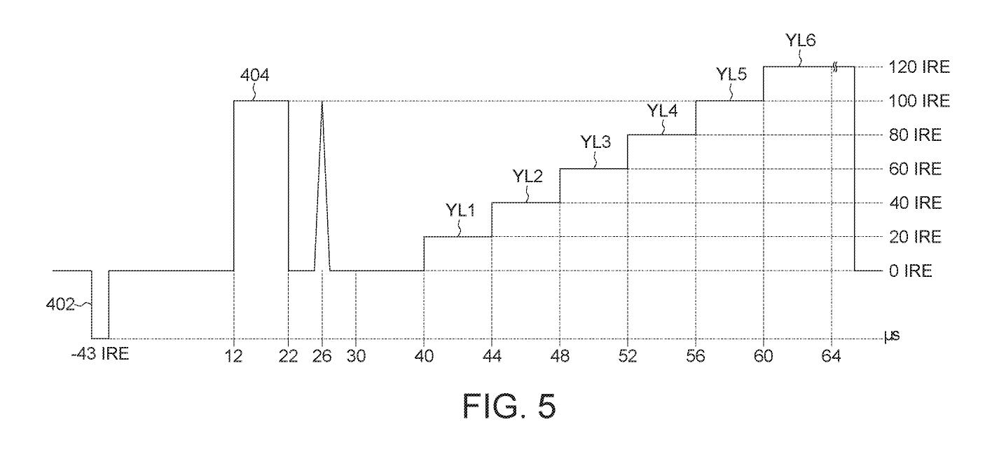

Referring to FIG. 5, an example of a waveform diagram of a composite luminance signal Y′ corresponding to the image of a particular line of a field is shown. The composite luminance signal Y′ includes a horizontal synchronization pulse 402, a white frame 404, and luminance signals YL1˜YL6.

The video level defines the magnitude of an image signal. As specified by the National Television System Committee (NTSC) of USA, the blanking level of an image is 0 IRE, the black level is +7.5 IRE, and the white level is +100 IRE. The blanking level is the reference level of an image signal (normally, 0 V). 1 IRE=7.14 mV.

For convenience of description, FIG. 5 only illustrates the DC level of the composite luminance signal Y′ corresponding to the luminance signal Y within the period of 40˜64 microseconds (μs) but does not illustrate the modulated carrier signal corresponding to the chrominance signal U and the chroma signal V. In the present embodiment, the composite luminance signal Y′ can correspond to 6 DC levels within the period of 40˜64 μs (1 unit includes 4 μs). As indicated in FIG. 5, the 6 DC levels are such as 20 IRE, 40 IRE, 60 IRE, 80 IRE, 100 IRE, and 120 IRE corresponding to the luminance signals YL1˜YL6 respectively. The DC levels correspond to different luminance signals Y of the first digital image signal D1 respectively. Although FIG. 5 only illustrates 6 DC levels, in practical operation, the composite luminance signal Y′ is digital signal and should be digital values corresponding to the DC levels mentioned above. In the present embodiment, 6 luminance signals YL1˜YL6 represent 6 different luminance signals Y, but the present embodiment is not limited thereto.

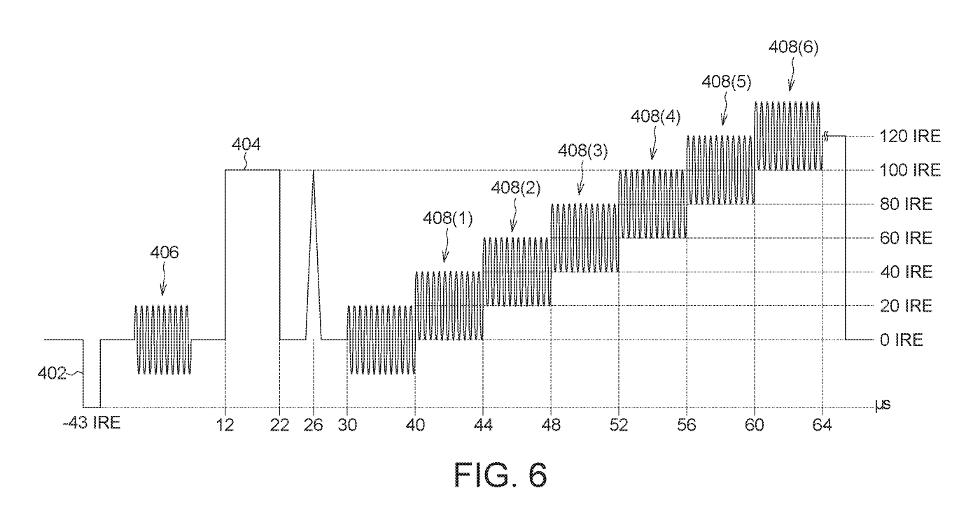

Referring to FIG. 6, an example of an analog composite video baseband signal CVBS1 is shown. The composite luminance signal Y′, having been processed with digital to analog conversion, allows the TV 302 to display a black and white TV image. The video composite circuit 312 can further combine the color carrier signal C including the chrominance signal U and the chroma signal V with the composite luminance signal Y′ to obtain the second digital image signal D2. The analog composite video baseband signal CVBS1 obtained after the digital to analog conversion of the second digital image signal D2 allows the TV 302 to display a color TV image.

The analog composite video baseband signal CVBS1 includes a color burst 406 having about 10 periods. The carrier signal provided by the color burst 406 can be used as a base carrier signal used as reference for the phase and amplitude in the following encoding process of the color information. The analog composite video baseband signal CVBS1 further has color information, such as color information 408(1)˜408(6). The color information includes 2 sets of quadrature components, and the modulation is performed on the carrier according to the frequency of the color burst 406. Both the phase and the amplitude of the modulated signal will determine the color performance of each pixel on the same line.

In FIG. 6, it can be assumed that the analog composite video baseband signal CVBS1 in the period of 40˜44 μs corresponds to yellow (the color information 408(1)), and the luminance signal thereof has a level of 20 IRE; the analog composite video baseband signal CVBS1 in the period of 44˜48 μs corresponds to cyan (the color information 408(2)), and the luminance signal thereof has a level of 40 IRE; the analog composite video baseband signal CVBS1 in the period of 48˜52 μs corresponds to green (the color information 408(3)), and the luminance signal thereof has a level of 60 IRE; the analog composite video baseband signal CVBS1 in the period of 52˜56 μs corresponds to purple (the color information 408(4)), and the luminance signal thereof has a level of 80 IRE; the analog composite video baseband signal CVBS1 in the period of 56˜60 μs corresponds to red (the color information 408(5)), and the luminance signal thereof has a level of 100 IRE; and, the analog composite video baseband signal CVBS1 in the period of 60˜64 μs corresponds to blue (the color information 408(6)), and the luminance signal thereof has a level of 120 IRE.

The analog composite video baseband signal CVBS1 transmits different color information 408(1)˜408(6) using the carrier signal of the same frequency. For example, in the NTSC standard, the carrier signal has a frequency of 3.58 MHz; in the phase alternating line (PAL) standard, the carrier signal has a frequency of 4.43 MHz

The analog composite video baseband signal CVBS1 distinguishes the color information through the control of phase shift. Assume there are M colors, then the phase difference between every two adjacent color information will be 360/M degree. Suppose M=6, then the phase difference between every two adjacent color information is 60 degree. Suppose the phase angle θ of the color information is adjusted by the way of phase leading or lagging. Assume the carrier signal is sin(ωt) before phase adjustment and the carrier signal is sin(ωt+e) or sin(ωt−θ) after phase adjustment. According to the NTSC standard, the phase angle θ=θ1 corresponding to yellow is 167.1 degree, the phase angle θ=θ2 corresponding to cyan is 283.5 degree, the phase angle θ=θ3 corresponding to green is 240.7 degree, the phase angle θ=θ4 corresponding to purple is 60.7 degree, the phase angle θ=θ5 corresponding to red is 103.5 degree, and the phase angle θ=θ6 corresponding to blue is 347.1 degree.

The standard of the composite video baseband signal CVBS also specifies the span of phase error of the carrier signal (for example, the error must be smaller than 2 degree). Therefore, it is very likely that the non-linearity of the DAC may cause the analog composite video baseband signal CVBS1 to violate the requirement specified in the standard of the composite video baseband signal and therefore affect the quality of the display frame of the TV.

The analog composite video baseband signal CVBS is generated through the modulation by using the luminance signal and the color information. The luminance signal is represented by different voltage, and the larger the voltage, the larger the luminance; the smaller the voltage, the smaller the luminance. As indicated in FIG. 1, the larger the value inputted to the DAC, the larger the difference between actual output voltage and ideal output voltage. That is, due to the non-linearity of the DAC, the larger the input voltage, the larger the difference between actual output voltage and ideal output voltage. Therefore, when the TV receives the analog composite video baseband signal CVBS1 and displays a frame, color distortion of the frame will become even worse under a large luminance. That is, the larger the luminance, the larger the voltage corresponding to the luminance signal, and the larger the difference between the analog voltage converted by the DAC 306 and the ideal voltage, and therefore the larger the shift in the carrier phase of the color information. That is, the carrier phase of the color information will be leading or lagging more. According to the present embodiment, different compensation phases are assigned to the color information corresponding to different luminance signals, thereby resolving the problem of the phase of carrier corresponding to the color information being shifted due to the non-linear conversion curve of the DAC.

Refer to FIG. 3 again. The color generation circuit 310 preferably further includes a storage circuit 318 used for storing a look-up table. The look-up table includes a number of level mapping relationships between S luminance levels and S compensation phases. S is an integer larger than 1. The color generation circuit 310 obtains a compensation phase corresponding to the selected level according to the level mapping relationships.

TABLE 1

| Luminance | | | | | | |
|---|---|---|---|---|---|---|
| level | L1 | L2 | L3 | L4 | L5 | L6 |
| Range of | Y_{c} ≤ 60 | 60 < Y_{c} ≤ 80 | 80 < Y_{c} ≤ 100 | 100 < Y_{c} ≤ 120 | 120 < Y_{c} ≤ 140 | 140 < Y_{c} ≤ 160 |
| luminance | | | | | | |
| voltage | | | | | | |
| (IRE) | | | | | | |
| Range of | Y_{c} ≤ 337 | 337 < Y_{c} ≤ 450 | 450 < Y_{c} ≤ 562 | 562 < Y_{c} ≤ 675 | 675 < Y_{c} ≤ 787 | 787 < Y_{c} ≤ 900 |
| luminance | | | | | | |
| value | | | | | | |
| Compensation | θm1 | θm2 | θm3 | θm4 | θm5 | θm6 |
| phase | | | | | | |
| Sine | sin(wt + θ | sin(wt + θ | sin(wt + θ | sin(wt + θ | sin(wt + θ | sin(wt + θ |
| values | c + θm1) | c + θm2) | c + θm3) | c + θm4) | c + θm5) | c + θm6) |
| | or | or | or | or | or | or |
| | sin(wt − θ | sin(wt − θ | sin(wt − θ | sin(wt − θ | sin(wt − θ | sin(wt − θ |
| | c − θm1) | c − θm2) | c − θm3) | c − θm4) | c − θm5) | c − θm6) |
| Cosine | cos(wt + | cos(wt + | cos(wt + | cos(wt + | cos(wt + | cos(wt + |
| values | θc + θm1 ) | θc + θm2) | θc + θm3) | θc + θm4) | θc + θm5) | θc + θm6) |
| | or | or | or | or | or | or |
| | cos(wt − θ | cos(wt − θ | cos(wt − θ | cos(wt − θ | cos(wt − θ | cos(wt − θ |
| | c − θm1) | c − θm2) | c − θm3) | c − θm4) | c − θm5) | c − θm6) |

In Table 1, the value of S is exemplified by 6. Table 1 exemplarily illustrates 6 luminance levels L1˜L6 and the range of luminance voltage Yc of the luminance signal corresponding to the luminance levels L1˜L6. For example, when the luminance voltage Yc is smaller than or equal to 60 IRE, then the luminance level is determined as L1; when the luminance voltage Yc is larger than 60 IRE but smaller than or equal to 80 IRE, then the luminance level is determined as L2. Let the luminance signals YL1˜YL6 of FIG. 5 be taken for example. Since the voltages of the luminance signals YL1˜YL3 are smaller than or equal to 60 IRE, the luminance signals YL1˜YL3 belong to luminance level L1. The luminance signal YL4˜YL6 belong to the luminance levels L2˜L4 respectively. By determining the range of luminance voltage of the luminance signal, one of the luminance level L1˜L6 can be selected to be the selected level.

Table 1 further lists the range of luminance value corresponding to the luminance level. In the present embodiment, the luminance value is exemplified by digital values 0˜1023. For example, a luminance voltage of 60 corresponds to a luminance value of 337, so the luminance level L1 corresponds to the range of luminance value Yc′ smaller than or equal to 337.

Table 1 also lists the compensation phase corresponding to the luminance level. Different luminance levels correspond to different compensation phases. For example, the luminance levels L1˜L6 correspond to the compensation phases θm1˜θm6.

The larger the level of the luminance signal, the larger the selected level, and the larger the compensation phase. Moreover, the look-up table as indicated in Table 1 further includes at least one of a sine phase mapping relationship between a number of sine values and S compensation phases and a cosine phase mapping relationship between a number of cosine values and S compensation phases. For example, the compensation phase θm1 corresponds to sine value sin(ωt+θc+θm1) or sin(ωt−θc−θm1), and corresponds to cosine value cos(ωt+θc+θm1) or cos(ωt−θc−θm1). θc is the phase angle corresponding to different colors. For example, the phase angle θc equals to θ1 (i.e. 167.1 degree) when θc corresponds to yellow, the phase angle θc equals to θ2 (i.e. 283.5 degree) when θc corresponding to cyan, the phase angle θc equals to θ3 (i.e. 240.7 degree) when θc corresponds to green, the phase angle θc equals to θ4 (i.e. 60.7 degree) when θc corresponds to purple, the phase angle θc equals to θ5 (i.e. 103.5 degree) when θc corresponds to red, and the phase angle θc equals to θ6 (i.e. 347.1 degree) when θc corresponds to blue.

After looking up the table, the color generation circuit 310 of FIG. 3 encodes the chrominance signal U and the chroma signal V according to the sine value or cosine value obtained from Table 1 to obtain the chrominance signal U multiplied by the sine value and the chroma signal V multiplied by the cosine value or obtain the chrominance signal U multiplied by the cosine value and the chroma signal V multiplied by the sine value. Then, the chrominance signal U and the chroma signal V respectively multiplied by the sin value or the cosine values can be combined to obtain the color carrier signal C, which can be expressed as:

C=U*sin(ωt+θc+θm)+V*cos(ωt+θc+θm), or

C=U*cos(ωt+θc+θm)+V*sin(ωt+θc+θm), or

C=U*sin(ωt−θc−θm)+V*cos(ωt−θc−θm), or

C=U*cos(ωt−θc−θm)+V*sin(ωt−θc−θm).

According to the present embodiment, a compensation phase is provided to the color carrier signal C to compensate the phase shift occurring to the analog composite video baseband signal CVBS1 due to the non-linearity of the DAC. For example, if the non-linearity of the DAC 306 makes the phase of the analog composite video baseband signal CVBS1 be an leading phase θe, then the compensation phase of the color carrier signal C will be a lagging phase θm, such that the phase of the color information of the analog composite video baseband signal CVBS1 can be compensated, wherein θm is approximately equal to θe. Thus, by using the phase compensation which is a lagging phase θm for the color carrier signal C, the phase shift θe occurring to the analog composite video baseband signal CVBS1 due to the non-linearity of the DAC can be compensated.

Based on the comparison between the luminance signal and the S threshold values, the compensation circuit 308 determines the selected level corresponding to the luminance signal, wherein S is an integer larger than 1. As indicated in Table 1, the S threshold values are, for example, boundary values of the ranges of 6 luminance values corresponding to the luminance levels L1˜L6. For example, the S threshold values are digital values 337, 450, 562, 675, 787, and 900.

In an embodiment as indicated in FIG. 6, after the luminance level corresponding to each luminance signal is obtained, the color generation circuit 310 adjusts the phase of the chrominance signal U and the phase of the chroma signal V according to the compensation phase θm. The adjustment is performed through phase accumulation. That is, the compensation phase θm obtained from look-up table for the current time period will be equal to the sum of all actual compensation phases in the current time period and all actual compensation phases in all previous time periods. For example, the compensation phase of the color information 408(3) obtained from look-up table is equal to the sum of all actual compensation phases of the color information 408(1)˜408(3); the compensation phase of the color information 408(2) obtained from look-up table is equal to the sum of all actual compensation phases of the color information 408(1)˜408(2). Assume actual compensation phases of the color information 408(1)˜408(3) are θa1, θa2, and θa3 respectively, and the compensation phases of the color information 408(1)˜408(3) obtained from look-up table are θb1, θb2, and θb3 respectively, then θb1=θa1, θb2=θa1+θa2, θb3=θa1+θa2+θa3. That is, the actual compensation phase of the color information 408(3) θa3 can be expressed as: θa3=θb331 θa1−θa2. This method allows the carriers corresponding to the color information of different luminance signals to maintain continuality.

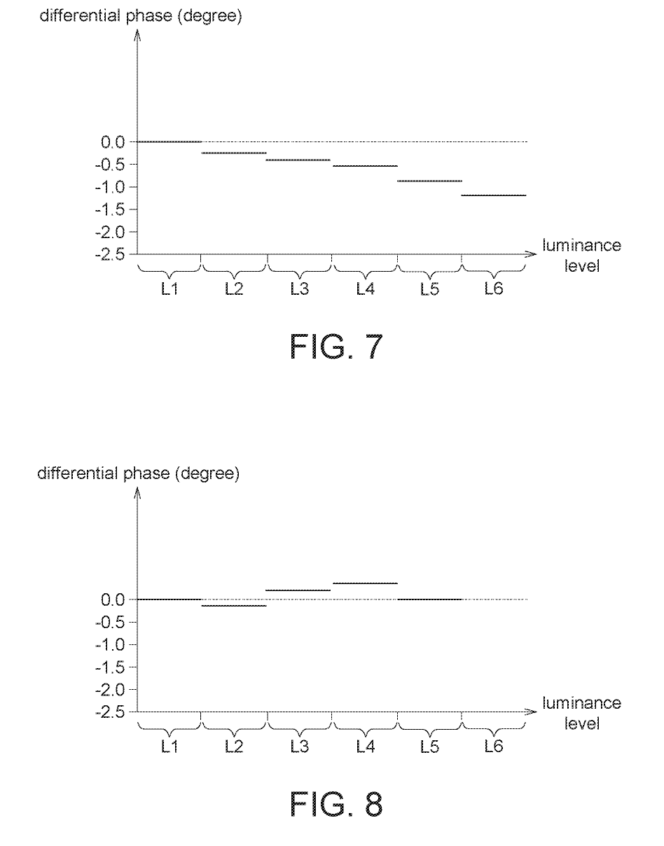

Refer to FIG. 7 and FIG. 8. FIG. 7 is a schematic diagram of outputted differential phase of a DAC obtained from the same color information under different luminance levels. FIG. 8 is a schematic diagram of outputted differential phase of a DAC obtained from the same color information under different luminance levels using the video encoding circuit according to an embodiment of the present disclosure. The above test is performed by using the instrument VM700 of Tektronix Inc.

As indicated in FIG. 7, before the phase compensation is performed, the differential phase gradually increases as the luminance level increases. The differential phase is the phase shift ee occurring to the analog composite video baseband signal CVBS1 due to the non-linearity of the DAC. In FIG. 7, the minimum differential phase is −1.18 degree, the maximum differential phase is 0 degree, and the peak to peak value of the differential phase is 1.18 degree. As indicated in FIG. 8, after the phase compensation is performed, the minimum differential phase is −0.12 degree, the maximum differential phase is 0.15 degree, and the peak to peak value of differential phase is 0.27 degree being far smaller the peak to peak value of differential phase of FIG. 7, that is, 1.18 degree. It can be understood from FIGS. 7 and 8 that once the phase compensation is performed according to the embodiments of the present disclosure, the differential phase will be significantly reduced and the differential phase will not increase along with the increase in luminance level.

Anyone ordinarily skilled in the art will understand that all the logic blocks, module steps, circuits and methods exemplified in above description can be implemented by circuits, hardware, firmware, or computer programs with processors, or a combination thereof.

As disclosed above, the video encoding circuit of the present disclosure can dynamically provide different compensation phases in response to the magnitude of the luminance signal to compensate the phase shift which occurs due to the non-linear of the DAC. Besides, the table look-up method can reduce hardware cost required for compensating the non-linearity of the DAC. For example, there is no need to have another DAC to compensate the non-linearity of the DAC. Even different DAC is replaced in the video output system, the non-linearity of the replaced DAC can be compensated by changing the content of the look-up table. Therefore, the present disclosure has the advantages of low cost and flexible design.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A video encoding circuit electrically connected to a digital to analog converter (DAC) for encoding a first digital image signal to a second digital image signal, wherein the first digital image signal comprises a luminance signal, a color signal and a decoding synchronization signal, and the video encoding circuit comprises:
a compensation circuit been arranged for determining a selected level corresponding to the luminance signal;
a color generation circuit electrically connected to the compensation circuit for generating a color carrier signal according to the selected level and the color signal; and
a video composite circuit electrically connected to the color generation circuit, the compensation circuit, and the DAC, wherein the video composite circuit generates the second digital image signal according to the luminance signal, the decoding synchronization signal, and the color carrier signal, and outputting the second digital image signal to the DAC.

2. The video encoding circuit according to claim 1, wherein the color generation circuit further comprises a storage circuit used for storing a look-up table, and the look-up table comprises:
a plurality of level mapping relationships between S luminance levels and S compensation phases, wherein the color generation circuit obtains a compensation phase corresponding to the selected level according to the level mapping relationships, and S is an integer larger than 1.

3. The video encoding circuit according to claim 2, wherein the larger the level of the luminance signal, the larger the selected level, and the larger the compensation phase.

4. The video encoding circuit according to claim 2, wherein the look-up table further comprises:
at least one of a sine phase mapping relationship between a plurality of sine values and the S compensation phases, and a cosine phase mapping relationship between a plurality of cosine values and the S compensation phases.

5. The video encoding circuit according to claim 1, wherein the color generation circuit generates a chrominance signal and a chroma signal according to the color signal, adjusts the phase of the chrominance signal and the phase of the chroma signal according to the selected level, and generates the color carrier signal according to the phase-adjusted chrominance signal and the phase-adjusted chroma signal.

6. The video encoding circuit according to claim 1, wherein the compensation circuit determines the selected level corresponding to the luminance signal according to the comparison between the luminance signal and S threshold values, and S is an integer larger than 1.

7. A video output system electrically connected to a TV, wherein the video output system comprises:
a video encoding circuit used for encoding a first digital image signal to a second digital image signal, wherein the first digital image signal comprises a luminance signal, a color signal and a decoding synchronization signal, and the video encoding circuit comprises:
a compensation circuit been arranged for determining a selected level corresponding to the luminance signal;
a color generation circuit electrically connected to the compensation circuit for generating a color carrier signal according to the selected level and the color signal; and
a video composite circuit electrically connected to the color generation circuit and the compensation circuit, wherein the video composite circuit generates the second digital image signal according to the luminance signal, the decoding synchronization signal and the color carrier signal; and
a DAC electrically connected to the video encoding circuit for encoding the second digital image signal to an analog composite video baseband signal and then outputting the analog composite video baseband signal to the TV.

8. The video output system according to claim 7, wherein the color generation circuit further comprises a storage circuit used for storing a look-up table, and the look-up table comprising:
a plurality of level mapping relationships between S luminance levels and S compensation phases, wherein the color generation circuit obtains a compensation phase corresponding to the selected level according to the level mapping relationships, and S is an integer larger than 1.

9. The video output system according to claim 8, wherein the larger the level of the luminance signal, the larger the selected level, and the larger the compensation phase.

10. The video output system according to claim 8, wherein the look-up table further comprises:
at least one of a sine phase mapping relationship between a plurality of sine values and the S compensation phases, and a cosine phase mapping relationship between a plurality of cosine values and the S compensation phases.

11. The video output system according to claim 7, wherein the color generation circuit generates a chrominance signal and a chroma signal according to the color signal, adjusts the phase of the chrominance signal and the phase of the chroma signal according to the selected level, and generates the color carrier signal according to the phase-adjusted chrominance signal and the phase-adjusted chroma signal.

12. The video output system according to claim 7, wherein the compensation circuit obtains the selected level corresponding to the luminance signal according to the comparison between the luminance signal and S threshold values, and S is an integer larger than 1.

13. A video signal encoding method used in a video encoding circuit for encoding a first digital image signal to a second digital image signal, wherein the digital image signal comprises a luminance signal, a color signal and a decoding synchronization signal, and the encoding method comprises:
determining a selected level corresponding to the luminance signal;
generating a color carrier signal according to the selected level and the color signal;
generating the second digital image signal according to the luminance signal, the decoding synchronization signal, and the color carrier signal; and
outputting the second digital image signal to a DAC.

14. The encoding method according to claim 13, further comprising:
storing a look-up table comprising a plurality of level mapping relationships between S luminance levels and S compensation phases, wherein S is an integer larger than 1.

15. The encoding method according to claim 14, further comprising:
obtaining a compensation phase corresponding to the selected level according to the level mapping relationships.

16. The encoding method according to claim 14, wherein the look-up table further comprises:
at least one of a sine phase mapping relationship between a plurality of sine values and the S compensation phases; and
a cosine phase mapping relationship between a plurality of cosine values and the S compensation phases.

17. The encoding method according to claim 13, further comprising:
generating a chrominance signal and a chroma signal according to the color signal;
adjusting the phase of the chrominance signal and the phase of the chroma signal according to the selected level; and
generating the color carrier signal according to the phase-adjusted chrominance signal and the phase-adjusted chroma signal.
